(19) United States
(12) Patent Application Publication
(10) Pub. No.: US 2026/0217479 A1
(43) Pub. Date: Jul. 30, 2026

(54) ARTICLE-TURNING DEVICE

(71) Applicant: The Procter & Gamble Company, Cincinnati, OH (US)

(72) Inventor: Kazuaki TAMEISHI, Kobe (JP)

(21) Appl. No.: 19/454,481

(22) Filed: Jan. 21, 2026

Related U.S. Application Data
(60) Provisional application No. 63/749,028, filed on Jan. 24, 2025.

(51) Int. Cl. B65G 47/244; B65G 47/84

(52) U.S. Cl. CPC B65G 47/244; B65G 47/846

(57) ABSTRACT

A device for changing an orientation of an article while moving the article in an orbital path about a first axis from an in-feed position to an output position. The device comprises a body and at least one article turning unit mounted to the body. The body is configured to rotate about a first axis, thus rotating each article turning unit about the first axis. Each article turning unit comprises an article holder configured to transport an article from the in-feed position to the output position, and a cam system configured to cause the article holder to rotate intermittently as the article turning unit is rotated about the first axis.

### CROSS REFERENCE TO RELATED APPLICATION

This application claims the benefit under 35 U.S.C. §119(e), of U.S. Provisional Application No. 63/749,028, filed January 24, 2025, which is herein incorporated by reference in its entirety.

### FIELD

The present disclosure relates to the field of series production, in particular, to devices for changing an orientation of an article, such as turning devices and turn-and-repitch devices.

### BACKGROUND

It is sometimes desirable to change an orientation of an article during manufacture and/or packaging of the article. A turning device or a turn-and-repitch device may be used to perform a change in orientation of an article.

A turning device or turn-and-repitch device may comprise a barrel cam and one or more article holding elements configured to move in an orbital path about the barrel cam to convey an article from an in-feed position to an output position. A cam follower engaged with the barrel cam is coupled to each article holding element, and the cam profile is configured such that the engagement of each cam follower with the barrel cam causes each article holding element to rotate as each article holding element moves about the barrel cam. In this way, an article conveyed by one of the article holding elements is rotated between the in-feed position and the output position. The cam profile may be configured such that each article holding element does not rotate at the in- feed position and the output position.

The cam profile is designed for a particular process performed on a particular type of article. If the design of the article and/or the production process is changed, a different cam profile may be required. A new cam with the required cam profile must then be designed and manufactured.

A replacement cam is also required periodically over the lifetime of a typical turning device or turn-and-repitch device, as the cam deteriorates over time.

As the cam is one of the largest parts of a typical turning device or turn-and-repitch device, manufacturing a new cam (either because a different cam profile is required or due to regular maintenance of the device) is time-consuming and costly. Further, replacement of the cam requires disassembly of the entire device.

### SUMMARY

According to an aspect of the present disclosure, there is provided a device for changing an orientation of an article while moving the article in an orbital path about a first axis from an in- feed position to an output position, the device comprising: one or more article turning units, each article turning unit comprising: an article holder for receiving the article at the in-feed position, holding the article while moving the article between the in-feed position and the output position, and releasing the article at the output position, the article holder being rotatable about a second axis to rotate the article between an input orientation, at the in-feed position, and an output orientation, at the output position, each article turning unit further comprising a cam systemcomprising: an input shaft comprising a cam; and an output shaft comprising a cam follower engaged with the cam, wherein the input shaft is driven and the output shaft is coupled to the article holder for rotating the article holder about the second axis, wherein the cam system is configured to convert a continuous rotation of the input shaft into an intermittent rotation of the output shaft, the intermittent rotation of the output shaft comprising periods of rotation of the output shaft, each period of rotation separated from a successive period of rotation by a period of no rotation of the output shaft about an axis of rotation of the output shaft, the device further comprising a body that is rotatable about the first axis, wherein at least one of the one or more article turning units is mounted to the body so that the at least one article turning unit is rotatable about the first axis.

This provides a device for changing an orientation of an article that has a simple design, is easy to maintain and repair, and is easier and less expensive to modify than existing devices. As each article turning unit has its own cam, the cam(s) may be smaller than the large central cam used in existing devices, and can therefore be manufactured and replaced more quickly, more easily, and at a lower cost.

In some embodiments, the first axis and each second axis are non-parallel to one another.

In some embodiments, each second axis is perpendicular to the first axis.

In some embodiments, for each article turning unit, a first plane perpendicular to an axis of rotation of the input shaft is perpendicular a second plane perpendicular to the axis of rotation of the output shaft.

In some embodiments, for each article turning unit, the axis of rotation of the input shaft is parallel to the first axis.

In some embodiments, for each article turning unit, the axis of rotation of the output shaft is parallel to the second axis.

In some embodiments, for each article turning unit, the axis of rotation of the output shaft is co-axial with the second axis.

In some embodiments, the device further comprises a gear system, comprising: a static primary gear; and for each article turning unit, a secondary gear, arranged to orbit about the primary gear, wherein, for each article turning unit, the input shaft of the cam system is coupled to the secondary gear to thereby be driven by a rotation of the secondary gear as the secondary gear orbits the primary gear.

This provides a mechanism for driving the input shaft of each cam system that is easy to maintain, as maintenance may require only periodic lubrication of the gears (depending on the material used for the gears).

In some embodiments, the primary gear is mounted co-axially with the first axis.

In some embodiments, each secondary gear is arranged to rotate about an axis parallel to the first axis.

In some embodiments, each secondary gear meshes with the primary gear.

In some embodiments, for each article turning unit: the cam comprises one or more threaded portions, and the cam follower comprises one or more index elements, configured to engage with the one or more threaded portions to produce the intermittent rotation of the output shaft.

The profile of the one or more threaded portions may be designed to provide a desired length of periods of no rotation of the output shaft and to provide a desired amount of rotation of the article holder.

In some embodiments, the cam system of at least one of the one or more article turning units is an index cam system, configured such that a direction of rotation of the article holder is the same for each period of rotation of the output shaft.

An index cam system may have a simple cam design, thus reducing the weight of the cam system.

In some embodiments, the one or more article turning units comprises: a first article turning unit comprising a first index cam system, wherein the article holder of the first article turning unit is configured to rotate in a clockwise direction during each period of rotation of the output shaft; and a second article turning unit comprising a second index cam system, wherein the article holder of the second article turning unit is configured to rotate in a counterclockwise direction during each period of rotation of the output shaft.

The article holder of the first article turning unit may configured to rotate in a clockwise direction during each period of rotation of the output shaft by a suitable configuration of the cam system of the first article turning unit. Similarly, the article holder of the second article turning unit may be configured to rotate in a counterclockwise direction during each period of rotation of the output shaft by a suitable configuration of the cam system of the second article turning unit.

In some embodiments, the cam system of at least one of the one or more article turning units is an oscillation cam system, configured such that a direction of rotation of the article holder alternates between clockwise and counterclockwise for successive periods of rotation of the output shaft.

In examples in which each output shaft undergoes two periods of no rotation during a full orbital path about the first axis, the use of an oscillation cam system enables each article holder to have the same input orientation each time the article holder reaches the in-feed position and the same output orientation each time the article holder reaches the output position. This enables a more effective design of the article holder.

In some embodiments, for each article turning unit, the article holder is configured to rotate by 90° during each period of rotation of the output shaft.

In some embodiments, for each article turning unit: each period of rotation of the output shaft corresponds to a 90° rotation of the input shaft; and each period of no rotation of the output shaft corresponds to a 90° rotation of the input shaft.

A 90° rotation of the input shaft for each period of no rotation of the output shaft enables the device to be suitable for a variety of process requirements.

In some embodiments, for each article turning unit, periods of no rotation of the output shaft alternate between a first period of no rotation and a second period of no rotation, wherein the input shaft is configured to rotate by a greater amount during the first period of no rotation of the output shaft than during the second period of no rotation of the output shaft.

A greater amount of rotation of the input shaft during a first period of no rotation than a second period of rotation may be used for rectangular-shaped articles, as the length of the orbital path for which no rotation of the article holder is required will depend on the orientation of the article. The device may be configured such that the first period of no rotation of the output shaft occurs at the in-feed position or such that the first period of no rotation of the output shaft occurs at the output position, depending on the input and output orientations of the article.

In some embodiments, for each article turning unit: each period of rotation of the output shaft corresponds to a 115° rotation of the input shaft; each first period of no rotation corresponds to a 90° rotation of the input shaft; and each second period of no rotation corresponds to a 40° rotation of the input shaft.

In some embodiments, 1° of rotation of the body about the first axis corresponds to 1° of rotation of each input shaft.

In some embodiments, at least one of the one or more article turning units comprises a reducer provided between the output shaft and the article holder, wherein the reducer is configured to modify an amount of rotation of the article holder relative to an amount of rotation of the output shaft such that the article holder is configured to rotate at a slower rate than the output shaft.

In some embodiments, at least one of the one or more article turning units comprises a multiplier provided between the output shaft and the article holder, wherein the multiplier is configured to modify an amount of rotation of the article holder relative to an amount of rotation of the output shaft such that the article holder is configured to rotate at a faster rate than the output shaft.

The use of a reducer or multiplier enables a variety of cam systems having different cam profiles to produce a desired change in orientation of an article, thus providing greater design flexibility.

In some embodiments, the device further comprises a central shaft at the first axis.

In some embodiments, the body comprises a housing rotatably mounted to the central shaft.

In some embodiments, each article holder is rotatably mounted to the housing.

### BRIEF DESCRIPTION OF THE DRAWINGS

FIG. 1 illustrates a schematic cross-sectional view of a device for changing an orientation of an article, according to an example;

FIG. 2 illustrates a cam system suitable for use in the device of FIG. 1;

FIG. 3 illustrates another cam system suitable for use in the device of FIG. 1;

FIG. 4 illustrates a schematic cross-sectional view of a device for changing an orientation of an article, according to another example; and

FIG. 5 illustrates an apparatus comprising a device for changing an orientation of an article, according to an example.

### DETAILED DESCRIPTION

Provided is a device for changing an orientation of an article while moving the article in an orbital path about a first axis from an in-feed position to an output position. The device comprises a body and at least one article turning unit mounted to the body. The body is configured to rotate about a first axis, thus rotating each article turning unit about the first axis. Each article turning unit comprises an article holder configured to transport an article from the in-feed position to the output position, and a cam system configured to cause the article holder to rotate intermittently as the article turning unit is rotated about the first axis.

The device may be used to change the orientation of any suitable article or component, including absorbent articles such as diapers, sanitary pads, incontinence pads, pantiliners, and the like, in a finished state or partially-finished state. The device may, for example, be employed in a system for manufacturing and/or packaging an article.

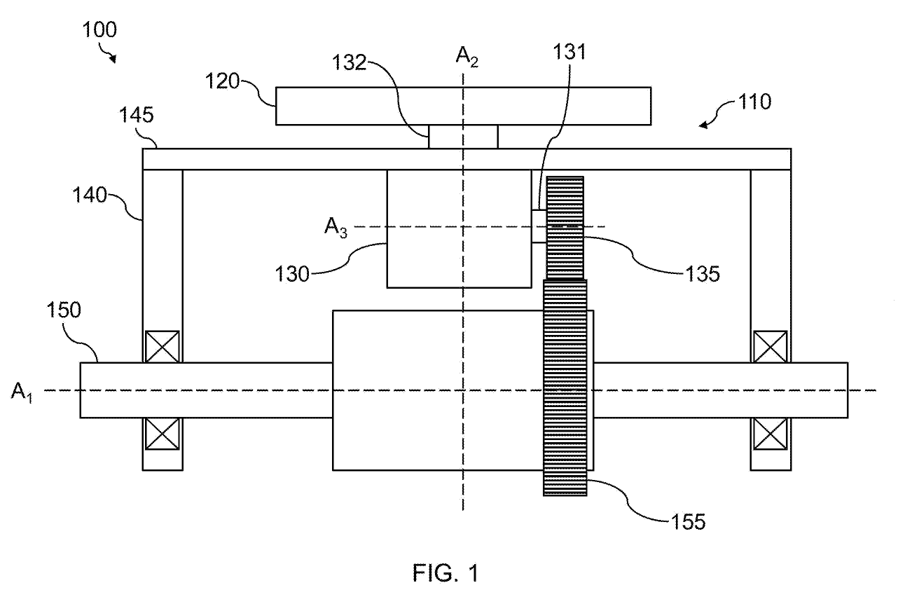

FIG. 1 illustrates a schematic cross-sectional view of a device 100 for changing an orientation of an article, according to an example. The device 100 is configured to change an orientation of an article while moving the article in an orbital path about a first axis A₁ from an in- feed position to an output position, as described in more detail below.

The device 100 comprises an article turning unit 110, which comprises an article holder 120 and a cam system 130. The device 100 further comprises a body 140, to which the article turning unit is mounted. The body 140, and thus the article turning unit 110, is rotatable about the first axis A₁. In this way, the article holder 120 of the article turning unit 110 is moveable along an orbital path between the in-feed position and the output position. The device 100 may further comprise a motor (not shown in FIG. 1) to drive rotation of the body about the first axis A₁.

In FIG. 1, the device 100 further comprises a central shaft 150 at the first axis A₁. The body 140 takes the form of a housing 145, which is rotatably mounted to the central shaft, thus enabling the body and the article turning unit 110 to rotate about the first axis A₁. It is to be understood that the body may be configured to rotate about the first axis A₁ using any suitable mechanism (for instance, using an internal gear, as described below).

The article holder 120 of the article turning unit is configured to receive the article at the in-feed position, hold the article while moving the article between the in-feed position and the output position, and release the article at the output position. The article holder 120 is further configured to change an orientation of the article from an input orientation at the in-feed position to an output orientation at the output position. In order to change the orientation of an article held by the article holder, the article holder is rotatable about a second axis A₂. The first axis A₁and the second axis A₂ may be non-parallel to one another; for instance, in FIG. 1, the second axis is perpendicular to the first axis.

In some examples, the article holder may be configured to receive and hold the article using a suction force (e.g. using a vacuum). The article holder may be configured to begin to apply the suction force at the in-feed position, or when the article holder is at a point in its orbital path between the output position and the in-feed position and moving towards the in-feed position, and to continue to apply the suction force until the article holder reaches the output position, at which point the article holder may be configured to stop applying the suction force in order to release the article.

Rotation of the article holder 120 of the article turning unit about the second axis A₂ is driven by the cam system 130, which comprises a driven input shaft 131 and an output shaft 132. The input shaft 131 comprises a cam (not visible in FIG. 1), while the output shaft 132 comprises a cam follower that is engaged with the cam. The output shaft is coupled to the article holder 120 to enable rotation of the article holder about the second axis A₂. In FIG. 1, the article holder is mounted on the output shaft such that the article holder is configured to rotate with the output shaft; however, in other examples, the article holder may be coupled to the output shaft such that the article holder is configured to rotate at a different rate to the output shaft, as described in more detail below.

The cam system 130 is configured to convert a continuous rotation of the input shaft 131 into an intermittent rotation of the output shaft 132 (thus resulting in an intermittent rotation of the article holder). The intermittent rotation of the output shaft comprises periods of rotation of the output shaft about an axis of rotation of the output shaft, separated by periods of no rotation of the output shaft about the axis of rotation of the output shaft (though it is to be understood that the output shaft continues to move, along with the remainder of the article turning unit, in the orbital path about the first axis A₁ during a period of no rotation of the output shaft).

The intermittent rotation of the output shaft 132, and thus the article holder 120, enables the article holder to have a first orientation aligned with the input orientation of the article while moving along a first segment of the orbital path that includes the in-feed position, a second orientation aligned with the output orientation of the article while moving along a second segment of the orbital path that includes the output position, and to rotate between the first orientation and the second orientation while moving about the orbital path between the first segment and the second segment. In other words, the device 100 is configured such that the output shaft undergoes a first period of no rotation while moving along the first segment, and a second period of no rotation while moving along the second segment to enable the article to be transferred to and from the article holder.

The cam system 130 may be configured such that the article holder has the same input orientation (or an equivalent orientation, e.g. rotated by 180° in the case of a rectangular-shaped article holder) each time the article holder reaches the in-feed position and the same output orientation (or an equivalent orientation) each time the article holder reaches the output position. To enable this, the rate of rotation of the input shaft may be such that the input shaft completes an integer number of 360° rotations for each 360° rotation of the body about the first axis A₁, and/or such that the body completes an integer number of 360° rotations about the first axis for each 360° rotation of the input shaft. For instance, the input shaft may be configured to rotate about its axis of rotation at the same rate as the body 140 is configured to rotate about the first axis A₁.

The cam system may be an index cam system, in which the direction of rotation of the article holder is the same for each period of rotation of the output shaft, or an oscillation cam system, in which the direction of rotation of the article holder alternates between clockwise and counterclockwise for successive periods of rotation of the output shaft. The intermittent rotation of the output shaft (and thus of the article holder) is described in more detail below.

The axes of rotation of the input shaft 131 and output shaft 132 of the cam system 130 may depend on design requirements of the device 100. In FIG. 1, an axis of rotation A₃ of the input shaft is parallel to the first axis A₁, and the axis of rotation of the output shaft is co-axial with the second axis A₂ (i.e. the output shaft is configured to rotate, during periods of rotation, about the second axis A₂). The axis of rotation A₃ of the input shaft and the axis of rotation of the output shaft are oriented such that a first plane perpendicular to an axis of rotation of the input shaft is perpendicular to a second plane perpendicular to the axis of rotation of the output shaft (i.e. the axis of rotation A₃ of the input shaft may be perpendicular to the axis of rotation of the output shaft, or the axis of rotation A₃ of the input shaft may be parallel to an axis that is perpendicular to the axis of rotation of the output shaft). The skilled person will appreciate that other configurations may be used; for instance, the axis of rotation of the output shaft may be parallel to, but not co- axial with, the second axis A₂.

The continuous rotation of the input shaft 131 of the cam system 130 may be driven by rotation of the body 140 of the device 100 about the first axis A₁. For instance, the device 100 illustrated in FIG. 1 further comprises a gear system comprising a static primary gear 155 (which is static with respect to the rotation of the body) and a secondary gear 135 arranged to orbit about the primary gear. In FIG. 1, the primary gear 155 is fixedly mounted on the central shaft 150, and is therefore mounted co-axially with the first axis A₁. The secondary gear is configured to orbit about the first axis A₁.

The secondary gear 135 is coupled to the input shaft 131 of the cam system 130 such that a rotation of the secondary gear as the secondary gear orbits about the primary gear drives rotation of the input shaft. In FIG. 1, the secondary gear 135 is mounted on the input shaft 131 such that the input shaft is configured to rotate with the secondary gear; however, the input shaft may be coupled to the secondary gear using any mechanism that enables the input shaft to be driven by the rotation of the secondary gear (for instance, the gear system may comprise one or more further gears provided between the secondary gear and the input shaft).

In FIG. 1, the secondary gear 135 meshes with the primary gear 155 (in other words, the secondary gear is configured to directly engage with the primary gear to orbit about the primary gear). Alternatively, the gear system may comprise one or more further gears provided between the secondary gear and the primary gear.

The axis of rotation of the secondary gear 135 may depend on design requirements of the device 100, and on the number and type of gears used in the gear system. In some examples, the secondary gear may be configured to rotate about an axis parallel to the first axis A₁. For instance, in FIG. 1, the secondary gear is configured to rotate about the third axis A₃.

In FIG. 1, the static primary gear 155 and the secondary gear 135 are both external gears (i.e. gears having teeth on an external circumference). In some examples, the static primary gear may be an internal gear (i.e. a gear having teeth on an internal circumference) encircling the body of the device such that the body rotates about the first axis by rotating within the internal gear. The secondary gear may then be configured to orbit about the first axis by moving about the internal circumference of the static primary gear.

Although in FIG. 1 the input shaft 131 is driven by a gear system, any suitable mechanism may be used to drive the input shaft as the article turning unit is rotated about the first axis A₁. For instance, one or more belts and/or one or more chains may be used to drive the input shaft. Further examples of suitable mechanisms will be apparent to the skilled person.

As described above, the cam system 130 is configured to convert a continuous rotation of the input shaft 131 into an intermittent rotation of the output shaft 132. The intermittent rotation of the output shaft may depend on the profile of the cam. For instance, the cam on the input shaft 131 may comprise one or more threaded portions (e.g. one or more grooves or ridges provided on the input shaft), and the cam follower may comprise one or more index elements, each configured to engage with the one or more threaded portions. The one or more index elements may be provided directly on the output shaft 132 or on a disc mounted on the output shaft co-axially with the axis of rotation of the output shaft.

The one or more threaded portions of the cam may each comprise one or more circular regions (in which the threaded portion describes an arc of a circle that is perpendicular to the axis of rotation of the input shaft 131) and one or more helical regions (in which the threaded portion is non-perpendicular to the axis of rotation of the input shaft). Engagement of an index element with a circular region may be held without rotation of the output shaft; therefore periods during which the one or more index elements are engaged only with a circular region of the one or more threaded portions are periods of no rotation. Engagement of an index element with a helical region causes the output shaft to rotate about its axis of rotation as the input shaft rotates. In this way, the intermittent rotation of the output shaft may be produced.

The relationship between the continuous rotation of the input shaft 131 and the intermittent rotation of the output shaft 132 depends on the design of the cam system. For instance, where the cam comprises one or more threaded portions and the cam follower comprises one or more index elements configured to engage with the one or more threaded portions, the amount by which the input shaft 131 rotates (i.e. the angular range of the rotation) during periods of no rotation of the output shaft 132 depends on the length of each circular region, and the amount by which the input shaft 131 rotates during periods of rotation of the output shaft 132 depends on the length of each helical region. The amount by which the output shaft 132 rotates during periods of rotation depends on the length and angle (with respect to the axis of rotation of the input shaft 131) of each helical region.

The direction of rotation of the output shaft 132 depends on the direction in which the helical region is slanted. If the cam system 130 is an index cam system, each helical region of each threaded portion is slanted in the same direction to produce intermittent rotation in which the direction of rotation of the output shaft (and thus the article holder 120) is the same for each period of rotation. If the cam system is an oscillation cam system, each threaded portion may comprise a first helical region slanted in a first direction to produce a clockwise rotation of the article holder during a first period of rotation of the output shaft, and a second helical region slanted in a second, opposite direction to produce a counterclockwise rotation of the article holder during a second period of rotation of the output shaft, with a circular region of the threaded portion provided between the first helical region and the second helical region.

The relationship between the continuous rotation of the input shaft 131 and the intermittent rotation of the output shaft 132 may be configured to produce a desired change in orientation of the article holder 120 between the in-feed position and the output position.

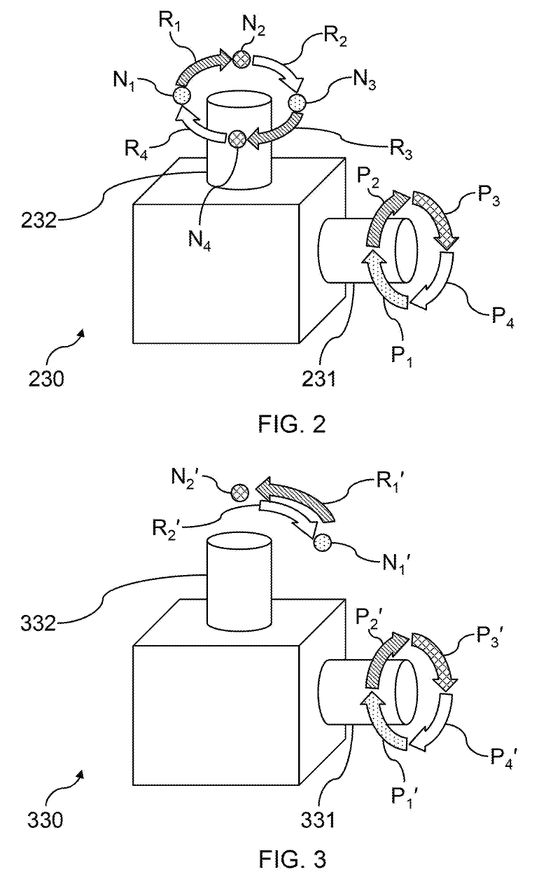

FIG. 2 illustrates a cam system 230 suitable for use in the device 100. The cam system 230 comprises an input shaft 231 comprising a cam and an output shaft 232 comprising a cam follower. The cam system 230 is configured to convert a continuous rotation of the input shaft into an intermittent rotation of the output shaft. The cam system 230 is an index cam system, configured such that the direction of rotation of the output shaft 232 is the same for each period of rotation of the output shaft.

A first portion P₁ of a first cycle of the continuous rotation of the input shaft 231, during which the input shaft rotates by 90°, results in a first period of no rotation N₁ of the output shaft 232. A second portion P₂ of the first cycle of the continuous rotation of the input shaft 231, during which the input shaft rotates by a further 90°, results in a first period of rotation R₁ of the output shaft 232, during which the output shaft rotates by 90° in a clockwise direction. A third portion P₃ of the first cycle of the continuous rotation of the input shaft 231, during which the input shaft rotates by a further 90°, results in a second period of no rotation N₂ of the output shaft 232. A fourth portion P₄ of the first cycle of the continuous rotation of the input shaft 231, during which the input shaft rotates by a further 90°, thus completing the first cycle of the continuous rotation of the input shaft 231, results in a second period of rotation R₂ of the output shaft 232, during which the output shaft rotates by a further 90° in a clockwise direction. Thus, a 360° rotation of the input shaft 231 results in a 180° rotation of the output shaft 232.

A second cycle of the continuous rotation of the input shaft 231 results in a further 180° rotation of the output shaft 232. A first portion P₁ of the second cycle of the continuous rotation of the input shaft 231, during which the input shaft again rotates by 90°, results in a third period of no rotation N₃ of the output shaft 232. A second portion P₂ of the second cycle of the continuous rotation of the input shaft 231 results in a third period of rotation R₃ of the output shaft 232, during which the output shaft rotates by a further 90° in a clockwise direction. A third portion P₃ of the second cycle of the continuous rotation of the input shaft 231 results in a fourth period of no rotation N₄ of the output shaft 232. A fourth (and final) portion P₄ of the second cycle of the continuous rotation of the input shaft 231 results in a fourth period of rotation R₄ of the output shaft 232, during which the output shaft rotates by a further 90° in a clockwise direction. Thus, a 360° rotation of the output shaft 232 corresponds to two 360° rotations of the input shaft.

FIG. 3 illustrates another cam system 330 suitable for use in the device 100. The cam system 330 comprises an input shaft 331 comprising a cam and an output shaft 332 comprising a cam follower. The cam system 330 is configured to convert a continuous rotation of the input shaft into an intermittent rotation of the output shaft. The cam system 330 is an oscillation cam system, configured such that a direction of rotation of the output shaft 332 alternates between clockwise and counterclockwise for successive periods of rotation of the output shaft.

A first portion P₁' of a cycle of the continuous rotation of the input shaft 331, during which the input shaft rotates by 90°, results in a first period of no rotation N₁' of the output shaft 332. A second portion P₂' of the cycle of the continuous rotation of the input shaft 331, during which the input shaft rotates by a further 90°, results in a first period of rotation R₁' of the output shaft 232, during which the output shaft rotates by 90° in a counterclockwise direction. A third portion P₃' of the cycle of the continuous rotation of the input shaft 331, during which the input shaft rotates by a further 90°, results in a second period of no rotation N₂' of the output shaft 332. A fourth portion P₄' of the cycle of the continuous rotation of the input shaft 331, during which the input shaft rotates by a further 90°, thus completing the cycle of the continuous rotation of the input shaft 231, results in a second period of rotation R₂' of the output shaft 232, during which the output shaft rotates by 90° in a clockwise direction. Thus, for each 360° rotation of the input shaft 231, the output shaft rotates by 90° in a counterclockwise direction in a first period of rotation and then 90° in a clockwise direction in a second period of rotation.

The cam systems 230 and 330 illustrated in FIGS. 2 and 3 each provide an output shaft that is configured to rotate by 90° during each period of rotation. The use of either cam system in the device 100 illustrated in FIG. 1, in which the article holder 120 is mounted on the output shaft such that the article holder is configured to rotate with the output shaft during each period of rotation of the output shaft, would result in the article holder 120 being configured to rotate by 90° during each period of rotation of the output shaft.

Returning to FIG. 1, it is to be understood that, while the cam systems 230 and 330 illustrated in FIGS. 2 and 3 provide suitable examples, the cam system 130 may be configured such that the output shaft 132 rotates by any desired amount during each period of rotation, and such that periods of rotation and no rotation of the output shaft correspond to any desired amount of rotation of the input shaft 131, depending on a desired change in orientation of an article held by the article holder 120, an angular difference between the in-feed position and the output position, a size of the article to be held by the article holder, the input orientation of the article (with respect to a direction of movement of the article), the output orientation of the article (with respect to a direction of movement of the article), and the relationship between the rotation of the input shaft and the rotation of the body 140 about the first axis A₁.

For instance, the device 100 may be configured such that a 1° rotation of the body 140 about the first axis A₁ corresponds to a 1° rotation of the input shaft 131 (i.e. the input shaft may be configured to rotate about its axis of rotation at the same rate as the body is configured to rotate about the first axis A₁). In such an case, a cam system 130 configured such that the input shaft 131 rotates by 90° during each period of rotation of the output shaft 132 and each period of rotation of the output shaft would be suitable for a variety of process requirements where the in-feed position and the output position are opposite one another (or close to being opposite one another), as a period of no rotation during which the body rotates by 90° about the first axis A₁ enables the article holder to remain in a suitable orientation for transferring the article to/from the article holder for a (relatively large) range of lengths of the article with respect to the direction of movement of the article.

In some examples, the input shaft 131 may be configured to rotate by different amounts during periods of rotation of the output shaft 132 and periods of no rotation of the output shaft. For instance, a desired amount of rotation of the input shaft for periods of no rotation may be determined based on the length of the article in the direction of movement of the article at the in- feed position and the output position (which determines the length of orbital path required to transfer the article to the article holder at the in-feed position and from the article holder at the output position respectively). The amount by which the input shaft is configured to rotate during periods of rotation of the output shaft may then be set accordingly (i.e. so that the article holder is in a period of no rotation with the desired orientation at the in-feed position and the output position).

In some examples, the input shaft may be configured to rotate by different amounts during different periods of rotation of the output shaft and/or different periods of no rotation of the output shaft. This may, for example, be the case if the device is designed to change an orientation of a rectangular-shaped article by 90°, as a longer period of no rotation will be required at the transfer position (i.e. the in-feed position or output position) at which the side of the article parallel to (or closest to parallel to) the direction of movement of the article is longer. For example, the cam system 130 may be configured such that periods of no rotation of the output shaft alternate between a first period of no rotation and a second period of no rotation, with the input shaft rotating by a greater amount during the first period of no rotation than the second (and thus, a greater proportion of the orbital path about the first axis A₁ is spent with the article holder 120 in the first period of no rotation than in the second period of no rotation). The device 100 may then be configured such that the article holder is at the in-feed position during the first period of no rotation if the input orientation of the article is such that the longest side of the article is parallel to the direction of movement of the article, or such that the article holder is at the output position during the first period of no rotation if the input orientation of the article is such that the longest side of the article is parallel to the direction of movement of the article.

For instance, the cam system 130 may be configured such that each period of rotation of the output shaft 132 corresponds to a 115° rotation of the input shaft 131, and each period of rotation of the output shaft corresponds to a 115° rotation of the input shaft, and periods of no rotation of the output shaft alternate between a first period of no rotation, corresponding to a 90° rotation of the input shaft, and a second period of no rotation, corresponding to a 40° rotation of the input shaft. In a device in which the input shaft is configured to rotate about its axis of rotation at the same rate as the body 140 is configured to rotate about the first axis A₁ and the article holder 120 is configured to rotate at the same rate as the output shaft, this would result in the article holder having an intermittent rotation the same as or similar to conventional devices for changing the orientation of a rectangular-shaped article.

The amount by which the article holder 120 rotates during each period of rotation of the output shaft 132 depends on a ratio between the rate at which the article holder is configured to rotate and the rate at which the output shaft is configured to rotate, as well as on the amount by which the output shaft is configured to rotate during each period of rotation. In FIG. 1, the article holder is configured to rotate at the same rate as the output shaft; however, in some examples, the article holder may be coupled to the output shaft such that the article holder is configured to rotate at a different rate to the output shaft.

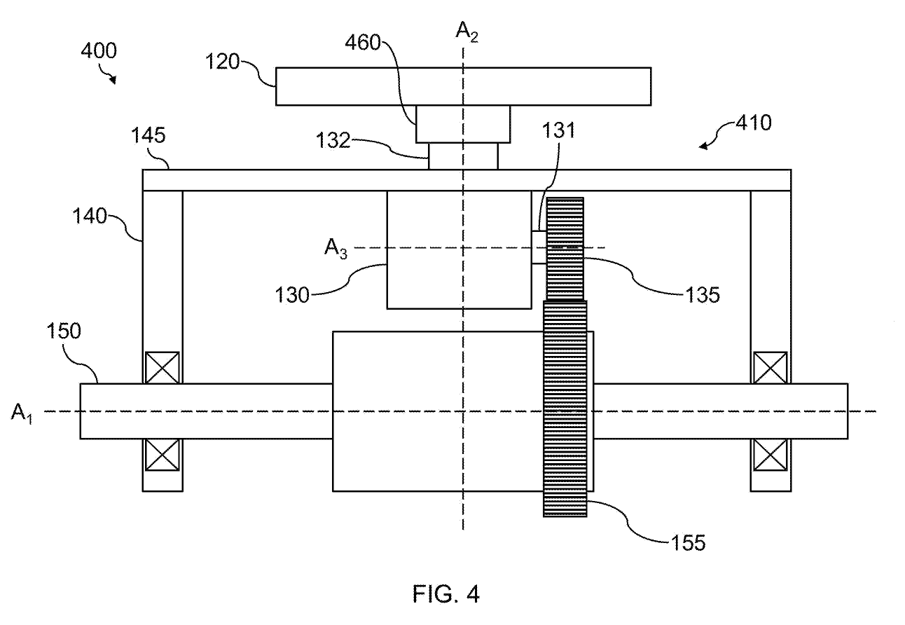

FIG. 4 illustrates a schematic cross-sectional view of a device 400 for changing an orientation of an article, according to an example. The device 400 is similar to the device 100 illustrated in FIG. 1, comprising an article turning unit 410 and body 140 configured to rotate about a first axis A₁. The body 140 is identical to the body 140 of the device 100 shown in FIG. 1. The article turning unit 410 is similar to the article turning unit 110 of the device 100 shown in FIG. 1, comprising an article holder 120 and a cam system 130 as described above; however, the article turning unit 410 further comprises a reducer 460 provided between the output shaft 132 of the cam system 130 and the article holder 120.

The reducer 460 is configured to modify an amount of rotation of the article holder 120 relative to an amount of rotation of the output shaft 132 such that the article holder is configured to rotate at a slower rate than the output shaft. The reducer may comprise a first gear mounted co-axially on the output shaft 132 and a second gear secured to the article holder and driven by the first gear. The first gear may mesh with the second gear, or the reducer may comprise one or more further gears provided between the first gear and the second gear.

Alternatively, a multiplier may be used in place of the reducer 460 to modify an amount of rotation of the article holder 120 relative to an amount of rotation of the output shaft 432 such that the article holder is configured to rotate at a faster rate than the output shaft. The modifier may similarly comprise a first gear mounted co-axially on the output shaft 132 and a second gear secured to the article holder and driven by the first gear. The first gear may mesh with the second gear, or the multiplier may comprise one or more further gears provided between the first gear and the second gear.

In FIGS. 1 and 4, the devices 100 and 400 each have a single article turning unit. However, in some examples, a device for changing an orientation of an article may comprise a plurality of article turning units, each article turning unit comprising an article holder and a cam system as described with reference to FIGS. 1 and/or 4, with each article turning unit being mounted to the body of the device so that each article turning unit is rotatable about a first axis.

In some examples, each article turning unit may be configured to provide the same change in orientation of an article between the in-feed position and the output position. In other examples, the device may comprise a first article turning unit configured to provide a first change in orientation of an article and a second article turning unit configured to provide a second change in orientation of an article, such that a first article moved to the output position by the first article turning unit has a first output orientation at the output position, while a second article moved to the output position by the second article turning unit has a second output orientation at the output position. For instance, the device may be configured such that articles arriving at the output position alternate between a first output orientation, in which the article has been rotated by a certain amount in a clockwise direction (e.g. 90° clockwise) and a second output orientation, in which the article has been rotated by a certain amount in a counterclockwise direction (e.g. 90° counterclockwise). This may, for example, be achieved by a combination of one or more first article turning units each comprising a first index cam system, for which the article holder is configured to rotate in a clockwise direction, and one or more second article turning units each comprising a second index cam system, for which the article holder is configured to rotate in a counterclockwise direction. Alternatively, different output orientations may be provided using a plurality of article turning units each comprising an oscillation cam system, with at least one article turning unit configured such that the article holder is configured to rotate in a clockwise direction while moving from the in-feed position to the output position, and at least one article turning unit configured such that the article holder is configured to rotate in a counterclockwise direction while moving from the in-feed position to the output position. Different output orientations may additionally or alternatively be provided by the use of one or more reducers and/or one or more multipliers (for instance, the article holder of a first article turning unit may be directly secured to the output shaft of the cam system, while a reducer or multiplier may be provided between the output shaft and the article holder in a second article turning unit).

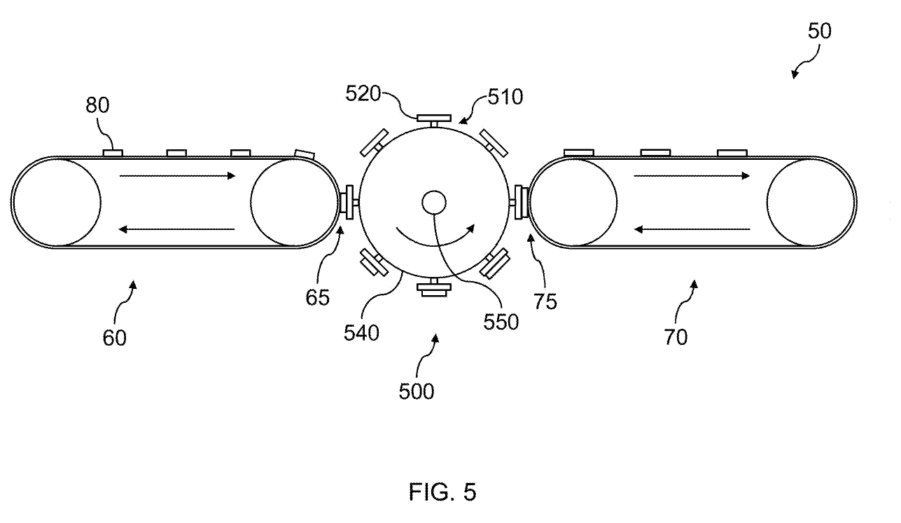

FIG. 5 illustrates an example apparatus 50 in which a device for changing an orientation of an article, according to the present disclosure, may be used. The apparatus 50 comprises an input conveyor 60, an output conveyor 70 and a device 500 for changing an orientation of an article, according to an example. The apparatus 50 may, for instance, form part of a system for manufacturing and/or packaging an article.

The input conveyor 60 is configured to convey at least one article 80 to an in-feed position 65 of the device 500. In FIG. 5, a plurality of articles are conveyed by the input conveyor as part of a flow of moving articles.

The device 500 is configured to change the orientation of the at least one article 80 while moving the article from the in-feed position 65 to an output position 75. The device 500 comprises a plurality of article turning units 510, each as described above, a body 540, and a central shaft 550. The body is configured to rotate about a first axis that is co-axial with the central shaft, and each article turning unit 510 is mounted to the body such that each article turning unit is rotatable about the first axis. In FIG. 5, the article turning units 510 are mounted to the same body; however, in some examples, the device may comprise more than one body (e.g. with each body taking the form of a rotatable arm), and different article turning units may be mounted to different bodies (e.g. each article turning unit may be mounted to a respective body).

As each article 80 reaches the in-feed position 65, the article is received by an article holder 520 of one of the article turning units 510. The article is then held by the article holder as the body rotates about the first axis, thus moving the article in an orbital path about the first axis from the in-feed position to the output position 75, where the article is released by the article holder. The output conveyor 70 is configured to receive the article from the article holder at the output position 75, and to convey the at least one article away from the output position.

As described above, each article turning unit 510 is configured to change an orientation of an article from an input orientation to an output orientation while moving the article from the in- feed position 65 to the output position 75. The device 500 may be configured such that the article holder of each article turning unit reaches the in-feed position during a first period of no rotation and reaches the output position during a second period of no rotation, undergoing at least one period of rotation while moving between the in-feed position and the output position.

In some examples, the device 500 may be configured such that different article turning units provide different changes in orientation between the in-feed position and the output position, as described above. For instance, the device 500 may be configured such that a flow of moving articles along the output conveyor alternates between an article having a first orientation and an article having a second orientation.

In some examples, the apparatus 50 may be configured to adjust a pitch between adjacent articles in a flow of moving articles, by configuring the input conveyor and output conveyor to convey articles at different speeds from one another. Thus, adjacent articles may have a first pitch while being conveyed to the in-feed position 65 by the input conveyor 60, and a second, different pitch while being conveyed away from the output position 75 by the output conveyor 70.

In some examples, a first operation (e.g. a step in manufacturing or packaging the article that requires the article to have the input orientation) may be performed on each article 80 as the article is conveyed along the input conveyor 60 and/or a second operation (e.g. a step in manufacturing or packaging the article that requires the article to have the output orientation) may be performed on each article 80 as the article is conveyed along the output conveyor 70. In examples in which the device is configured such that different article turning units provide different changes in orientation between the in-feed position and the output position, different operations may be performed on articles having different output orientations as the articles are conveyed along the output conveyor 70.

It is to be understood that the input conveyor 60 is one example of a mechanism by which the at least one article 80 is conveyed to the in-feed position 65, and that any suitable mechanism for conveying the at least one article 80 to the in-feed position 65 (e.g. a rotating drum) may be used in place of the input conveyor. Similarly, any suitable mechanism for conveying the at least one article 80 away from the output position 75 may be used in place of the output conveyor 70.

### Combinations

A1. A device (100, 400, 500) for changing an orientation of an article (80) while moving the article in an orbital path about a first axis (A₁) from an in-feed position (65) to an output position (75), the device comprising: one or more article turning units (110, 410, 510), each article turning unit comprising: an article holder (120, 520) for receiving the article at the in-feed position, holding the article while moving the article between the in-feed position and the output position, and releasing the article at the output position, the article holder being rotatable about a second axis (A₂) to rotate the article between an input orientation, at the in-feed position, and an output orientation, at the output position, each article turning unit further comprising a cam system (130, 230, 330) comprising: an input shaft (131, 231, 331) comprising a cam; and an output shaft (132, 232, 332) comprising a cam follower engaged with the cam, wherein the input shaft is driven and the output shaft is coupled to the article holder for rotating the article holder about the second axis, wherein the cam system is configured to convert a continuous rotation of the input shaft into an intermittent rotation of the output shaft, the intermittent rotation of the output shaft comprising periods of rotation (R₁, R₂, R₃, R₄, R₁', R₂') of the output shaft, each period of rotation separated from a successive period of rotation by a period of no rotation (N₁, N₂, N₃, N₄, N₁', N₂') of the output shaft about an axis of rotation of the output shaft, the device further comprising a body (140, 540) that is rotatable about the first axis, wherein at least one of the one or more article turning units is mounted to the body so that the at least one article turning unit is rotatable about the first axis.

A2. The device (100, 400, 500) of paragraph A₁, wherein the first axis (A₁) and each second axis (A₂) are non-parallel to one another.

A3. The device (100, 400, 500) of paragraph A₂, wherein each second axis (A₂) is perpendicular to the first axis (A₁).

A4. The device (100, 400, 500) of any of paragraphs A1 to A3, wherein, for each article turning unit (110, 410, 510), a first plane perpendicular to an axis of rotation (A₃) of the input shaft (131, 231, 331) is perpendicular to a second plane perpendicular to the axis of rotation of the output shaft (132, 232, 332).

A5. The device (100, 400, 500) of any of paragraphs A1 to A4, wherein, for each article turning unit (110, 410, 510), the axis of rotation (A₃) of the input shaft (131, 231, 331) is parallel to the first axis (A₁).

A6. The device (100, 400, 500) of any of paragraphs A1 to A5, wherein, for each article turning unit (110, 410, 510), the axis of rotation of the output shaft (132, 232, 332) is parallel to the second axis (A₂).

A7. The device (100, 400, 500) of paragraph A6, wherein, for each article turning unit (110, 410, 510), the axis of rotation of the output shaft is co-axial with the second axis (A₂).

A8. The device (100, 400, 500) of any of paragraphs A1 to A7, further comprising a gear system, comprising: a static primary gear (155); and for each article turning unit (110, 410, 510), a secondary gear (135), arranged to orbit about the primary gear, wherein, for each article turning unit, the input shaft (131, 231, 331) of the cam system (130, 230, 330) is coupled to the secondary gear to thereby be driven by a rotation of the secondary gear as the secondary gear orbits the primary gear.

A9. The device (100, 400, 500) of paragraph A8, wherein the primary gear (155) is mounted co-axially with the first axis (A₁).

A10. The device (100, 400, 500) of paragraph A8 or A9, wherein each secondary gear (135) is arranged to rotate about an axis parallel to the first axis (A₁).

A11. The device (100, 400, 500) of any of paragraphs A8 to A10, wherein each secondary gear (135) meshes with the primary gear (155).

A12. The device (100, 400, 500) of any of paragraphs A1 to A11, wherein, for each article turning unit (110, 410, 510): the cam comprises one or more threaded portions, and the cam follower comprises one or more index elements, configured to engage with the one or more threaded portions to produce the intermittent rotation of the output shaft (132, 232, 332).

A13. The device (100, 400, 500) of any of paragraphs A1 to A12, wherein the cam system (230) of at least one of the one or more article turning units (110, 410, 510) is an index cam system, configured such that a direction of rotation of the article holder (120, 520) is the same for each period of rotation (R₁, R₂, R₃, R₄) of the output shaft (232).

A14. The device (500) of paragraph A13, wherein the one or more article turning units (510) comprises: a first article turning unit comprising a first index cam system (230), wherein the article holder (120, 520) of the first article turning unit is configured to rotate in a clockwise direction during each period of rotation (R₁, R₂, R₃, R₄) of the output shaft (232); and a second article turning unit comprising a second index cam system, wherein the article holder of the second article turning unit is configured to rotate in a counterclockwise direction during each period of rotation of the output shaft.

A15. The device (100, 400, 500) of any of paragraphs A1 to A14, wherein the cam system (330) of at least one of the one or more article turning units (110, 410, 510) is an oscillation cam system, configured such that a direction of rotation of the article holder alternates between clockwise and counterclockwise for successive periods of rotation (R₁', R₂') of the output shaft (332).

A16. The device (100, 400, 500) of any of paragraphs A1 to A15, wherein, for each article turning unit (110, 410, 510), the article holder (120, 520) is configured to rotate by 90° during each period of rotation (R₁, R₂, R₃, R₄, R₁', R₂') of the output shaft (132, 232, 332).

A17. The device (100, 400, 500) of any of paragraphs A1 to A16, wherein, for each article turning unit (110, 410, 510): each period of rotation (R₁, R₂, R₃, R₄, R₁', R₂') of the output shaft corresponds to a 90° rotation of the input shaft (131, 231, 331); and each period of no rotation (N₁, N₂, N₃, N₄, N₁', N₂') of the output shaft corresponds to a 90° rotation of the input shaft (131, 231, 331).

A18. The device (100, 400, 500) of any of paragraphs A1 to A16, wherein, for each article turning unit (110, 410, 510), periods of no rotation of the output shaft (132) alternate between a first period of no rotation and a second period of no rotation, wherein the input shaft (131) is configured to rotate by a greater amount during the first period of no rotation of the output shaft than during the second period of no rotation of the output shaft.

A19. The device (100, 400, 500) of paragraph A18, wherein, for each article turning unit (110, 410, 510): each period of rotation of the output shaft (132) corresponds to a 115° rotation of the input shaft (131); each first period of no rotation corresponds to a 90° rotation of the input shaft; and each second period of no rotation corresponds to a 40° rotation of the input shaft.

A20. The device (100, 400, 500) of any of paragraphs A1 to A19, wherein 1° of rotation of the body (140, 540) about the first axis (A₁) corresponds to 1° of rotation of each input shaft (131, 231, 331).

A21. The device (100, 400, 500) of any of paragraphs A1 to A20, wherein at least one of the one or more article turning units (110, 410, 510) comprises a reducer (460) provided between the output shaft (132, 232, 332) and the article holder (120, 520), wherein the reducer is configured to modify an amount of rotation of the article holder relative to an amount of rotation of the output shaft such that the article holder is configured to rotate at a slower rate than the output shaft.

A22. The device (100, 400, 500) of any of paragraphs A1 to A20, wherein at least one of the one or more article turning units (110, 410, 510) comprises a multiplier provided between the output shaft (132, 232, 332) and the article holder, wherein the multiplier is configured to modify an amount of rotation of the article holder relative to an amount of rotation of the output shaft such that the article holder is configured to rotate at a faster rate than the output shaft.

A23. The device (100, 400, 500) of any of paragraphs A1 to A22, wherein the device further comprises a central shaft (150, 550) at the first axis (A₁).

A24. The device (100, 400, 500) of paragraph A23, wherein the body (140, 540) comprises a housing (145) rotatably mounted to the central shaft (150, 550).

A25. The device (100, 400, 500) of paragraph A24, wherein each article holder (120, 520) is rotatably mounted to the housing (145).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as "40 mm" is intended to mean "about 40 mm."

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A device for changing an orientation of an article while moving the article in an orbital path about a first axis from an in-feed position to an output position, the device comprising:
one or more article turning units, each article turning unit comprising:
an article holder for receiving the article at the in-feed position, holding the article while moving the article between the in-feed position and the output position, and releasing the article at the output position,
the article holder being rotatable about a second axis to rotate the article between an input orientation, at the in-feed position, and an output orientation, at the output position,
each article turning unit further comprising a cam system comprising:
an input shaft comprising a cam; and
an output shaft comprising a cam follower engaged with the cam, wherein the input shaft is driven and the output shaft is coupled to the article holder for rotating the article holder about the second axis,
wherein the cam system is configured to convert a continuous rotation of the input shaft into an intermittent rotation of the output shaft, the intermittent rotation of the output shaft comprising periods of rotation of the output shaft, each period of rotation separated from a successive period of rotation by a period of no rotation of the output shaft about an axis of rotation of the output shaft,
the device further comprising a body that is rotatable about the first axis, wherein at least one of the one or more article turning units is mounted to the body so that the at least one article turning unit is rotatable about the first axis.

2. The device of claim 1, wherein the first axis and each second axis are non-parallel to one another.

3. The device of claim 2, wherein each second axis is perpendicular to the first axis.

4. The device of claim 1, wherein, for each article turning unit, a first plane perpendicular to an axis of rotation of the input shaft is perpendicular to a second plane perpendicular to the axis of rotation of the output shaft.

5. The device of claim 1, wherein, for each article turning unit, the axis of rotation of the input shaft is parallel to the first axis.

6. The device of claim 1, wherein, for each article turning unit, the axis of rotation of the output shaft is parallel to the second axis.

7. The device of claim 6, wherein, for each article turning unit, the axis of rotation of the output shaft is co-axial with the second axis.

8. The device of claim 1, further comprising a gear system, comprising:
a static primary gear; and
for each article turning unit, a secondary gear, arranged to orbit about the primary gear,
wherein, for each article turning unit, the input shaft of the cam system is coupled to the secondary gear to thereby be driven by a rotation of the secondary gear as the secondary gear orbits the primary gear.

9. The device of claim 8, wherein the primary gear is mounted co-axially with the first axis.

10. The device of claim 8, wherein each secondary gear is arranged to rotate about an axis parallel to the first axis.

11. The device of claim 8, wherein each secondary gear meshes with the primary gear.

12. The device of claim 1, wherein, for each article turning unit:
the cam comprises one or more threaded portions, and
the cam follower comprises one or more index elements, configured to engage with the one or more threaded portions to produce the intermittent rotation of the output shaft.

13. The device of claim 1, wherein the cam system of at least one of the one or more article turning units is an index cam system, configured such that a direction of rotation of the article holder is the same for each period of rotation of the output shaft.

14. The device of claim 13, wherein the one or more article turning units comprises:
a first article turning unit comprising a first index cam system, wherein the article holder of the first article turning unit is configured to rotate in a clockwise direction during each period of rotation of the output shaft; and
a second article turning unit comprising a second index cam system, wherein the article holder of the second article turning unit is configured to rotate in a counterclockwise direction during each period of rotation of the output shaft.

15. The device of claim 1, wherein the cam system of at least one of the one or more article turning units is an oscillation cam system, configured such that a direction of rotation of the article holder alternates between clockwise and counterclockwise for successive periods of rotation of the output shaft.

16. The device of claim 1, wherein, for each article turning unit, the article holder is configured to rotate by 900 during each period of rotation of the output shaft.

17. The device of claim 1, wherein, for each article turning unit:
each period of rotation of the output shaft corresponds to a 900 rotation of the input shaft;
and each period of no rotation of the output shaft corresponds to a 900 rotation of the input shaft.

18. The device of claim 1, wherein, for each article turning unit, periods of no rotation of the output shaft alternate between a first period of no rotation and a second period of no rotation, wherein the input shaft is configured to rotate by a greater amount during the first period of no rotation of the output shaft than during the second period of no rotation of the output shaft.

19. The device of claim 18, wherein, for each article turning unit:
each period of rotation of the output shaft corresponds to a 115° rotation of the input shaft;
each first period of no rotation corresponds to a 900 rotation of the input shaft; and
each second period of no rotation corresponds to a 400 rotation of the input shaft.

20. The device of claim 1, wherein 10 of rotation of the body about the first axis corresponds
to 1° of rotation of each input shaft.

21. The device of claim 1, wherein at least one of the one or more article turning units comprises a reducer provided between the output shaft and the article holder, wherein the reducer is configured to modify an amount of rotation of the article holder relative to an amount of rotation of the output shaft such that the article holder is configured to rotate at a slower rate than the output shaft.

22. The device of claim 1, wherein at least one of the one or more article turning units comprises a multiplier provided between the output shaft and the article holder, wherein the multiplier is configured to modify an amount of rotation of the article holder relative to an amount of rotation of the output shaft such that the article holder is configured to rotate at a faster rate than the output shaft.
